(19) United States
(12) Patent Application Publication
(10) Pub. No.: US 2002/0190826 A1
(43) Pub. Date: Dec. 19, 2002

(54) Electromagnet for moving ferromagnetic scrap

(75) Inventor: Danilo Molteni, Manerbio (IT)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: SGM Gantry S.p.A.

(21) Appl. No.: 10/216,426

(22) Filed: Aug. 9, 2002

Related U.S. Application Data
(63) Continuation of application No. PCT/IT01/00537, filed on Oct. 23, 2001.

(30) Foreign Application Priority Data
Oct. 27, 2000 (IT) MI2001A 02345

(51) Int. Cl. H01F 7/20

(52) U.S. Cl. 335/291

(57) ABSTRACT

An electromagnet consists of an external case 1 enclosing a first solenoid 2 inside which there are concentrically arranged an internal case 3 enclosing a second solenoid 4 wound around a pole core 5, said elements being closed at the top by a cover 6 and at the bottom by a ring 7 of nonmagnetic steel and by a pole shoe 8. A central aperture 9 extends across the full height of the electromagnet through cover 6, core 5 and pole shoe 8 and allows to deviate into pole shoe 8 the flux lines which tend to close at infinity. In this way the scrap pick is more compact and more evenly distributed, and the formation of cusps in the remaining scrap is reduced so as to shorten the time of operations such as the unloading of wagons, caissons, containers and the like.

The present invention relates to electromagnets for moving ferromagnetic scrap, and in particular to an electromagnet of parallelepipedal shape provided with a central slit.

It is known that to load ferromagnetic scrap in melt furnaces there are used electromagnets which lift the scrap and directly place it into the load basket of the furnace or onto conveyor belts or vibrating chutes. The scrap can be taken from a deposit or directly from the transport means by which it reached the foundry, goods wagon or truck, so as to avoid an intermediate moving.

Conventional electromagnets, both with a single solenoid or two concentric solenoids, have the drawback of creating cusps in the scrap remaining on the ground after the lifting. In other words, the removal of scrap is not uniform layer by layer but requires several lifting operations with an inevitable lengthening of the furnace loading time.

Moreover the lifted material is not quite compact and evenly distributed, whereby it can be unstable this resulting in the risk of fall during the moving. In this respect, FIG. 1 shows an example of a conventional single-solenoid electromagnet with a scrap pick in layers, with a succession from top to bottom of high-density scrap A, medium-density scrap B, low-density scrap C and finally a central bunch of very-low-density scrap D.

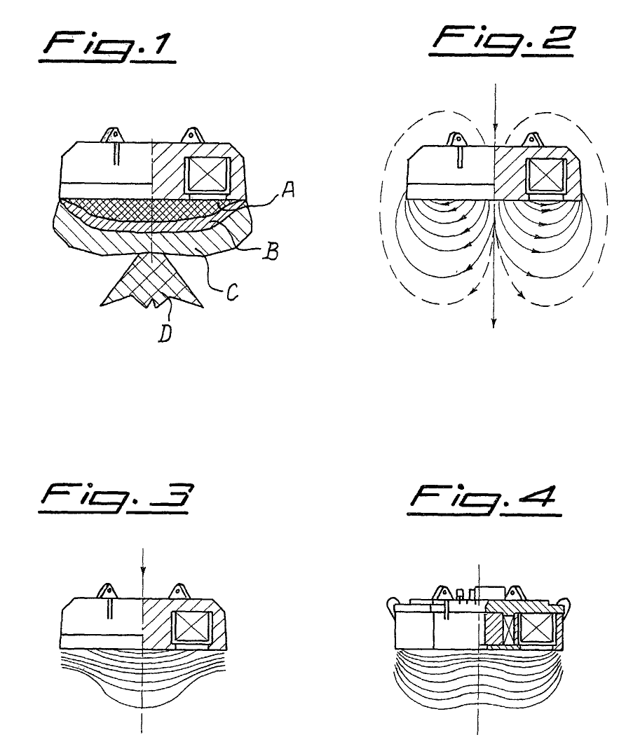

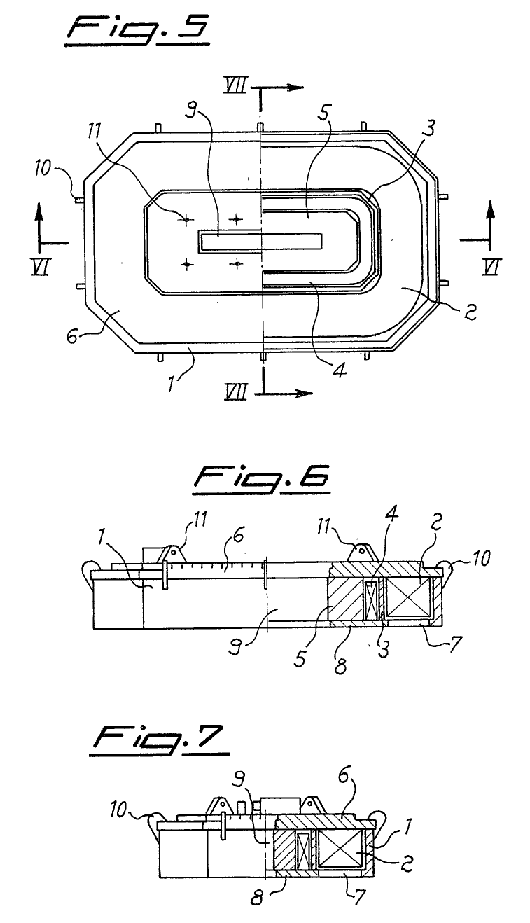

This behaviour of the scrap is a consequence of the uneven magnetic field created by the electromagnet. In particular, in the central area of the ferromagnetic circuit the flux lines, which excite the magnet through air, tend to close at infinity or however with a very long and dispersive path which implies a low attraction field gradient, as illustrated in FIG. 2. As a result the equivalent lines of the magnetic field through air are significantly far from the active surface of the electromagnet at its central portion, as illustrated in FIG. 3.

Therefore the object of the present invention is to provide an electromagnet which overcomes the above-mentioned drawbacks.

This object is achieved by means of an electromagnet having a central aperture. Other advantageous features are disclosed in the dependent claims.

A first main advantage of the present electromagnet is that of creating a more homogeneous magnetic field. This results in the scrap pick being more compact and more evenly distributed, and in reducing the formation of cusps in the remaining material so as to shorten the furnace loading time.

A further advantage of this electromagnet comes from the fact that the presence of the aperture involves an increase in the surface which dissipates the heat produced by Joule effect.

Still another advantage of the present electromagnet in its parallelepipedal form is that of having a shape and size suitable for the precise insertion into the wagons or containers used to transport the scrap, so as to make even quicker the unloading thereof.

These and other advantages and characteristics of the electromagnet according to the present invention will be clear to those skilled in the art from the following detailed description of an embodiment thereof, with reference to the annexed drawings wherein:

FIGS. 1, 2 and 3 relate to a conventional electromagnet as explained above;

FIG. 4 is a cross-sectional view showing the pattern of the equivalent lines of the magnetic field through air for an electromagnet with two concentric solenoids according to the invention;

FIG. 5 is a partially see-through top plan view of said electromagnet of FIG. 4;

FIG. 6 is a longitudinal sectional view along line VI-VI of FIG. 5; and

FIG. 7 is a cross-sectional view along line VII-VII of FIG. 5

With reference to FIG.4, and in particular comparing it to FIG. 3, it is apparent for a person skilled in the art that the lines of the magnetic field of the electromagnet according to the present invention cover in an almost ideal pattern its volume of action. Therefore it is clear that such a magnet is capable of generating a much more homogeneous and compact scrap pick, thus achieving the object of the invention. This result is obtained by means of the structure illustrated in FIGS. 5 to 7.

As shown in these figures, the present electromagnet in its preferred embodiment consists of an external case 1, of rectangular shape with beveled angles, enclosing a first solenoid 2 inside which there are concentrically arranged an internal case 3 of similar shape enclosing a second solenoid 4 wound around a pole core 5 of ferromagnetic material of suitable permeability.

This group of elements is closed at the top by a cover 6, while at the bottom (i.e. on the magnetically active face) the external solenoid 2 is closed by a ring 7 of wear-resistant nonmagnetic steel, whereas the internal solenoid 4 and core 5 are closed by a pole shoe 8. The latter is made of the same ferromagnetic material of core 5, as are cases 1 and 3 and cover 6, whereby the internal solenoid 4 results inserted within the global pole core.

The novel aspect of the present invention is the central aperture 9 extending across the full height of the electromagnet through cover 6, core 5 and pole shoe 8. In the embodiment above said aperture takes the form of a longitudinally arranged slit with dimensions equal to about 25-30% of the magnet's length and 8-10% of the magnet's width.

The combination of the above-described two-solenoid structure with the central slit allows to deviate into pole shoe 8 the flux lines which tend to close at infinity, with a subsequent widening of the equivalent field lines as illustrated in FIG. 4. In this way a significant enhancement of the performance is achieved, which can be indicatively calculated as 20% more than a conventional electromagnet, in particular in operations such as the unloading of wagons, caissons, containers and the like.

To this purpose the magnet is also provided along its periphery with involute-shaped projections 10 to facilitate its introduction into and extraction from the scrap containers, typically by means of cables secured to suitable attachments 11 arranged on cover 6.

It is clear that the above-described and illustrated embodiment of the electromagnet according to the invention is just an example susceptible of various modifications. In particular, although it is preferable to use two concentric solenoids it is possible to achieve advantageous effects also when using the central aperture in a single-solenoid electromagnet. Moreover the above-illustrated rectangular shape may be changed for other applications different from that mentioned above, for which the present electromagnet has been specifically designed, whereby also the aperture may have a different shape.

1. Electromagnet including a case (1) enclosing at least one solenoid (2) inside which there is arranged a pole core (5), said case (1) being closed at the top by a cover (6) and at the bottom by a ring (7) of nonmagnetic material at said solenoid (2) and by a pole shoe (8) at said core (5), characterized in that it has a central aperture (9) extending across the full height of the electromagnet through the cover (6), the core (5) and the pole shoe (8).

2. Electromagnet according to claim 1, characterized in that the case (1) has a rectangular shape with beveled angles.

3. Electromagnet according to claim 2, characterized in that the central aperture (9) consists of a longitudinally arranged slit with dimensions equal to 25-30% of the electromagnet's length and 8-10% of the electromagnet's width.

4. Electromagnet according to one or more of the preceding claims, characterized in that inside the solenoid (2) there are concentrically arranged an internal case (3) enclosing a second solenoid (4) wound around the pole core (5).

5. Electromagnet according to one or more of the preceding claims, characterized in that it is provided along its periphery with involute-shaped projections (10).
